(19) United States
(12) Patent Application Publication
(10) Pub. No.: US 2007/0287771 A1
(43) Pub. Date: Dec. 13, 2007

(54) Silicone ink composition for inkjet printing, and image-forming method

(75) Inventors: Toshio Yamazaki, Annaka-shi (JP); Masayuki Yoshida, Annaka-shi (JP); Tsutomu Nakamura, Annaka-shi (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/808,200

(22) Filed: Jun. 7, 2007

(30) Foreign Application Priority Data
Jun. 9, 2006 (JP) 2006-160791

(51) Int. Cl. C09D 11/00

(52) U.S. Cl. 523/160; 524/500

(57) ABSTRACT

A silicone ink composition for inkjet printing which is composed of an organopolysiloxane having two or more alkenyl groups on the molecule, an organohydrogenpolysiloxane having two or more hydrosilyl groups on the molecule, a platinum catalyst, a reaction regulator, a pigment, a dispersant and a solvent lends itself well to use in printing and coating with an inkjet printer. An image can be formed by using an inkjet printer to print or coat the composition onto a recording medium, then crosslinking and/or bonding the composition.

### CROSS-REFERENCE TO RELATED APPLICATION

This non-provisional application claims priority under 35 U.S.C. §119(a) on Patent Application No. 2006-160791 filed in Japan on Jun. 9, 2006, the entire contents of which are hereby incorporated by reference.

### BACKGROUND OF THE INVENTION

1. Field of the Invention

The present invention relates to a silicone ink composition which is capable of being printed with an inkjet printer when printing or coating silicone ink onto a recording medium. The invention additionally relates to an image-forming method which uses such a silicone ink composition.

2. Prior Art

When printing is carried out on the surface of a molded material made of silicone rubber, because molded silicone rubber surfaces have a poor wettability to ordinary resin-based inks (resulting in poor leveling of the ink) and are difficult for such inks to adhere to, thermosetting silicone inks are generally used. Thermosetting silicone ink compositions composed of a pigment dispersed in a curable silicone composition such as a liquid silicone rubber composition have excellent leveling characteristics on and adherence to the surfaces of molded silicone rubber materials. Up until now, the printing of characters and images on the surface of molded silicone rubber materials using thermosetting silicone ink compositions has generally been carried out by screen printing or by spray painting after masking.

However, screen printing is a printing process in which a member of the printing machine, specifically the printing plate, comes into contact with the printing substrate, raising a concern that the condition of the substrate surface after printing may be damaged. When printing a thermosetting silicone ink composition onto a molded silicone rubber material, the process invariably must pass through a step in which the ink that has been applied to the printing substrate is cured by the application of heat. In multicolor printing, because this sequence is repeated for each color, the printing process takes a long time. Moreover, in cases where, in addition to multicolor printing, complicated characters and images are to be printed, printing plates for each color that are divided up into parts are required. The time and cost entailed in making such plates has impeded efforts to streamline printing.

Spray painting, on the other hand, does not involve direct contact with the printing substrate, and is particularly well-suited for large surface areas and full-surface coating. However, there are limits to the selective coating of ink that can be achieved by masking; high-precision characters and images cannot be printed in this way.

By contrast, inkjet printing, which is carried out by discharging minute droplets of ink from nozzles and printing them as dot units, is capable of non-contact, simultaneous multicolor printing at a high resolution and a high speed. Inkjet printing is thus employed in a broad range of applications. However, the printing substrates used for inkjet printing are almost exclusively substrates having ink-absorbing properties, such as paper, cardboard or wood. For printing onto substrates that do not have the ability to absorb ink, such as metals, plastics and rubber, methods have been proposed in which printing is carried out after first applying an ink-receiving layer to the substrate surface. However, this approach has the drawback that the surface properties unique to the substrate are lost. For inks composed of a volatile liquid (vehicle) within which has been dissolved a thermoplastic binder resin having leveling characteristics on and adherence to the printing substrate, direct inkjet printing is possible without applying an ink-receiving layer. Accordingly, methods for use with such inks have been developed in which, after printing, the ink is solidified by evaporating off the vehicle, thereby forming characters and images. However, suitable binder resins for cases in which the printing substrate is a molded silicone rubber material do not exist.

Prior art relating to the invention is described in, for example, JP No. 2993096, JP-A 4-248879, JP-A 10-245513, JP-A 11-181345 and JP-A 2002-338863.

### SUMMARY OF THE INVENTION

It is therefore an object of the present invention to provide silicone ink compositions which may be suitably used for printing and coating with an inkjet printer. Another object of the invention is to provide an image-forming method which involves printing such an ink composition with an inkjet printer.

As a result of extensive investigations on inkjet printing inks in which particular attention was paid to the properties of thermosetting silicone ink compositions on the surfaces of molded silicone rubber materials, we have discovered that silicone compositions containing the following ingredients are effective for use in inkjet printing:

### (A) an organopolysiloxane having two or more alkenyl groups on the molecule,

### (B) an organohydrogenpolysiloxane having two or more hydrosilyl groups on the molecule,

### (C) a platinum catalyst,

### (D) a reaction regulator,

### (E) a pigment,

### (F) a dispersant, and

### (G) a solvent.

### When inkjet printing is carried out using such compositions, the printability onto the surface of molded silicone rubber materials is excellent.

Accordingly, the invention provides a silicone ink composition for inkjet printing which is composed of (A) an organopolysiloxane having two or more alkenyl groups on the molecule, (B) an organohydrogenpolysiloxane having two or more hydrosilyl groups on the molecule, (C) a platinum catalyst, (D) a reaction regulator, (E) a pigment, (F) a dispersant, and (G) a solvent.

At least one type of pigment selected from the group consisting of inorganic pigments and organic pigments may be used as component E. The dispersant used as component F is preferably a silicone-modified resin, and more preferably at least one type of silicone-modified resin selected from the group consisting of amino group-containing silicone oils, carboxyl group-containing silicone oils, carbinol group-containing silicone oils, alkyl group-containing silicone oils and copolymers of a radical polymerizable monomer and a silicone oil in which one end of the molecular chain is terminated with (meth)acrylate group.

The solvent used as component G is preferably a low-molecular-weight organosiloxane having a boiling point at a pressure of 666 Pa of not above 100° C.

The silicone ink composition for inkjet printing of the invention is preferably adapted for printing onto a surface of a cured silicone rubber material.

The invention also provides an image-forming method which includes the steps of forming an image on a recording medium by inkjet printing using the foregoing silicone ink composition, then crosslinking the image formed by the silicone ink composition.

The curable silicone ink compositions for inkjet printing of the invention can be directly printed, without first providing an ink-receiving layer, onto a substrate lacking the ability to absorb ink, and in particular have excellent leveling characteristics on and adherence to the surfaces of molded silicone rubber materials. Moreover, because such silicone ink compositions stabilize dispersion of the pigment and are thus suitable for use in inkjet printing technology, they can be printed and coated with inkjet printers capable of achieving an excellent image quality.

In addition, the printed pattern can be adhesively fixed to the surfaces of molded silicone rubber materials by thermosetting, enabling high-value-added molded silicone rubber materials to be obtained which have a high-grade, aesthetically appealing printed image quality compared with prior-art products obtained by screen printing.

### DETAILED DESCRIPTION OF THE INVENTION

The invention is described more fully below.

Component A, which serves as the base polymer in the silicone ink composition of the invention, is an organopolysiloxane having two or more alkenyl groups on the molecule. Preferred examples of this organopolysiloxane include the organopolysiloxanes having alkenyl groups bonded to silicon atoms at both ends of the molecular chain or on side chains along the molecular chain (especially straight-chain diorganopolysiloxanes in which the main chain is composed of repeating diorganosiloxane units and both ends of the molecular chain are capped with triorganosiloxy groups) represented by general formula (1) below.

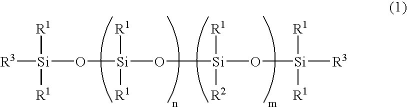

In formula (1), R₁ is a substituted or unsubstituted monovalent hydrocarbon group of 1 to 8 carbons, and preferably 1 to 6 carbons, having no aliphatic unsaturated bonds; R² is an alkenyl group of 2 to 8 carbons, and preferably 2 to 4 carbons; R³ is R¹ or R²; the letter m is an integer from 2 to 50 when R³═R¹, and is an integer from 0 to 50 when R³═R²; and the letter n is an integer from 0 to 1,000.

Illustrative examples of R¹ include alkyl and cycloalkyl groups such as methyl, ethyl, propyl, butyl, hexyl and cyclohexyl; aryl groups such as phenyl; aralkyl groups such as benzyl; and halogenated hydrocarbon groups such as chloromethyl, 3-chloropropyl and 3,3,3-trifluoropropyl. Preferred examples include methyl, phenyl and 3,3,3-trifluoropropyl. Methyl is especially preferred. Illustrative examples of R² include alkenyl and cycloalkenyl groups such as vinyl, allyl, butenyl, cyclopentenyl and cyclohexenyl. Vinyl is especially preferred.

When R³ is R¹, the letter m is an integer from 2 to 50, preferably from 2 to 20, and more preferably from 2 to 10. When R³ is R², the letter m is an integer from 0 to 50, preferably from 0 to 20, and more preferably from 1 to 10. The letter n is an integer from 0 to 1,000, preferably from 20 to 500, more preferably from 20 to 200, and even more preferably from 50 to 100.

Illustrative examples of component A include the compounds of formulas (2) to (4) below.

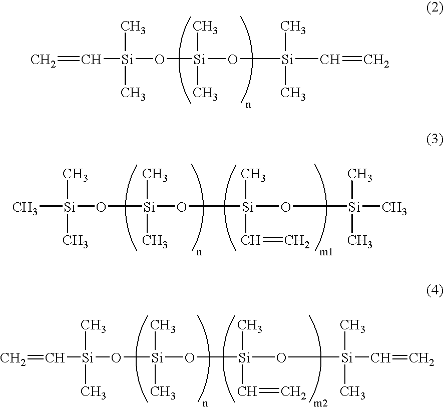

In formulas (2) to (4), m1 is an integer from 2 to 50, m2 is an integer from 1 to 50, and n is an integer from 0 to 1,000.

Component B, which is an organohydrogenpolysiloxane having two or more hydrosilyl groups (SiH groups), is a crosslinking agent for component A. The molecular structure is not subject to any particular limitation. For example, an organohydrogenpolysiloxane having a straight-chain, cyclic, branched, or three-dimensional network structure may be used, although the compound must have hydrogen atoms bonded to at least two, and preferably three or more, silicon atoms on the molecule. It is desirable for the compound to have generally from about 2 to about 200 SiH groups, and preferably from about 3 to about 100 SiH groups, on the molecule. The use of a compound having a number of silicon atoms (or a degree of polymerization) of from about 2 to about 300, and especially from about 3 to about 150, is preferred.

Exemplary organohydrogenpolysiloxanes include compounds of general formula (5) below having hydrosilyl groups at both ends of the molecular chain and/or on side chains along the molecular chain, such as organohydrogenpolysiloxanes capped at both ends of the molecular chain with triorganosiloxy groups, organohydrogensiloxane-diorganosiloxane copolymers capped at both ends of the molecular chain with triorganosiloxy groups, diorganopolysiloxanes capped at both ends of the molecular chain with diorganohydrogensiloxy groups, organohydrogenpolysiloxanes capped at both ends of the molecular chain with diorganohydrogensiloxy groups, organohydrogensiloxane-diorganosiloxane copolymers capped at both ends of the molecular chain with diorganohydrogensiloxy groups, and straight-chain organohydrogenpolysiloxanes exemplified by 1,1,3,3-tetraorganodisiloxanes. As used herein, “organo” preferably refers to a monovalent hydrocarbon group without aliphatic unsaturated bonds.

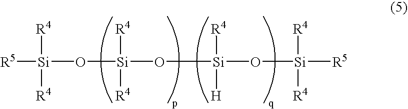

In formula (5), R⁴ is a substituted or unsubstituted monovalent hydrocarbon group of 1 to 8 carbons which preferably has no aliphatic unsaturated bonds; R⁵ is a hydrogen atom or R⁴; and the letter p is an integer from 0 to 100. When R⁵ is a hydrogen atom, the letter q is an integer from 0 to 100; and when R⁵═R⁴, the letter q is an integer from 2 to 100.

Illustrative examples of R⁴ include alkyl and cycloalkyl groups such as methyl, ethyl, propyl, butyl, hexyl and cyclohexyl; aryl groups such as phenyl; aralkyl groups such as benzyl; and halogenated hydrocarbon groups such as chloromethyl, 3-chloropropyl and 3,3,3-trifluoropropyl. Methyl, phenyl and 3,3,3-trifluoropropyl are preferred. Methyl is especially preferred. The letter p is an integer from 0 to 100, and preferably from 0 to 40. When R⁵ is a hydrogen atom, the letter q is an integer from 0 to 100, and preferably from 1 to 40. When R⁵═R⁴, the letter q is an integer from 2 to 100. and preferably from 3 to 40.

Illustrative examples of component B include the compounds of formulas (6) to (8) below.

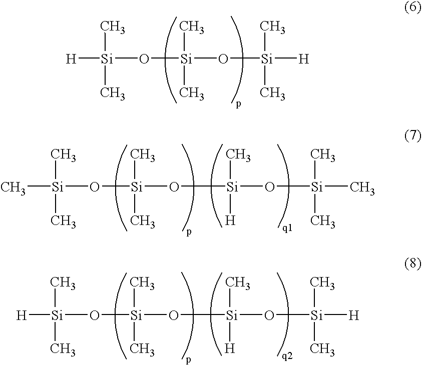

In formulas (6) to (8), p is an integer from 0 to 100, q1 is an integer from 2 to 100, and q2 is an integer from 0 to 100.

It is preferable to include component B in an amount containing from 0.5 to 10 moles, and especially from 1.5 to 5 moles, of SiH groups (i.e., hydrogen atoms bonded to silicon atoms) per mole of the alkenyl groups bonded to silicon atoms in component A. Alternatively, component B may be included in an amount of from 0.1 to 100 parts by weight, and especially from 0.1 to 50 parts by weight, per 100 parts by weight of component A.

Component C is a platinum catalyst which is a curing catalyst in a hydrosilylation reaction. Use may be made of a known catalyst, such as an alcohol solution of hexachloroplatinic acid. This is prepared by dissolving hexachloroplatinic (IV) acid hexahydrate in a solvent such as ethanol, isopropyl alcohol, n-butanol or 2-ethylhexyl alcohol, the concentration of metallic platinum being adjusted to about 0.1 to about 5 wt %, and preferably about 0.5 to about 2 wt %. Suitable use may also be made of a platinum complex compound solution obtained by neutralizing such an alcohol solution of hexachloroplatinic acid, attaching a diene compound as ligands, and replacing the alcohol with a suitable solvent. Illustrative examples of the diene include 1,3-butadiene, 1,5-hexadiene, 1,9-decadiene, cyclopentadiene, 1,3-cyclohexadiene, vinylnorbornene, 1,3-divinyl-1,1,3,3-tetramethyldisiloxane and 1,5-divinyl-1,1,3,3,5,5-hexamethyltrisiloxane. Illustrative examples of the solvent include, in addition to the above-mentioned alcohols, toluene, xylene, hexane, heptane, acetone, methyl ethyl ketone, methyl isobutyl ketone, ethyl acetate and butyl acetate, as well as organopolysiloxanes (silicone oils).

Component C is included in a catalytic amount, typically from 1 to 1,000 ppm, and especially from 5 to 200 ppm, of platinum metal based on the combined amount of components A and B.

Component D is a reaction regulator which is added to control the hydrosilylation reaction during storage of the inventive silicone ink composition and thereby extend the pot life. Component D is exemplified by acetylene alcohol-type compounds and polyfunctional unsaturated group-containing compounds. Illustrative examples of acetylene alcohol-type compounds include ethynyl cyclohexanol, 3,5-dimethyl-1-hexyn-3-ol and 3-methyl-1-tridecyn-3-ol. Illustrative examples of polyfunctional unsaturated group-containing compounds include 1,3,5-triallyl isocyanurate and 1,3,5,7-tetravinyl-1,3,5,7-tetramethylcyclotetrasiloxane.

The amount of component D included in the inventive composition is typically from 0.01 to 5 parts by weight, and preferably from 0.1 to 1 part by weight, per 100 parts by weight of component A.

Component E is a pigment which is included in the inventive silicone ink composition to impart the desired color. Use may be made of any type of inorganic pigment or organic pigment. Illustrative examples of inorganic pigments include carbon black, titanium oxide, red iron oxide, black iron oxide, titanium yellow, cobalt blue and ultramarine blue. Illustrative examples of organic pigments include condensed azo pigments (yellow, brown, red), isoindolinone pigments (yellow, orange), quinacridone pigments (red, violet), diketopyrrolopyrrole pigments (orange, red, violet), anthraquinone pigments (yellow, red, blue), dioxazine pigments (violet), benzimidazolone pigments (orange), copper phthalocyanine pigments (blue), and allylamide pigments (yellow). These may be suitably selected while taking into account such factors as the color tone and saturation of the adherend.

The amount of component E included in the inventive composition is set according to the target degrees of coloration and hiding. To achieve desirable physical properties, it is preferable to include component E is included in an amount of from 1 to 100 parts by weight per 100 parts by weight of component A.

Component F is a dispersant which is included in the silicone ink composition of the invention to enhance pigment dispersibility and prevent clogging of the nozzles in the inkjet printer head. The use of a silicone-modified resin is especially preferred. Exemplary dispersants include amino group-containing silicone oils, carboxyl group-containing silicone oils, carbinol group-containing silicone oils, silicone oils which contain long-chain alkyl groups (generally about 8 to about 30 carbons, and preferably about 10 to about 24 carbons) as a side-chain substituent group, and copolymers of a radical polymerizable monomer and a linear silicone oil in which one end of the molecular chain is terminated with (meth)acrylate group and another end is terminated with a triorganosilyl group such as trimethylsilyl group. Specific examples include those having formulas (9) to (15) below.

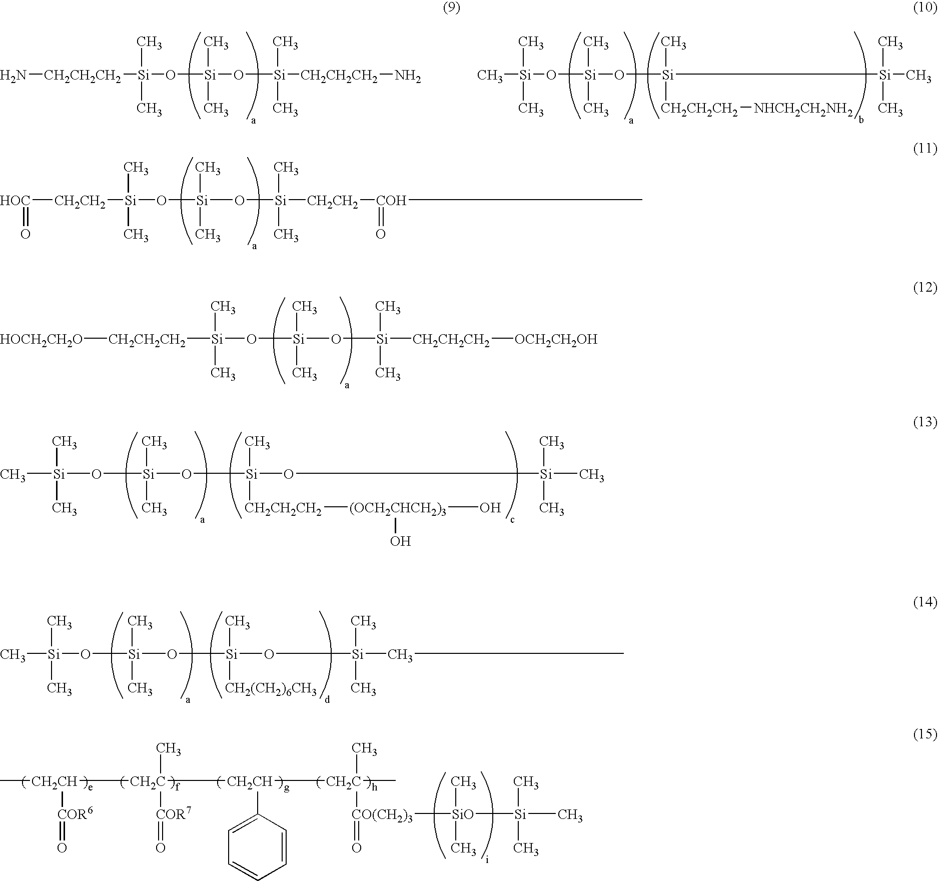

In formulas (9) to (15), R⁶ and R⁷ are each independently a hydrogen atom or a monovalent hydrocarbon group of 1 to 12 carbons which is either unsubstituted or is hydroxy- or halogen-substituted. Also, the letter a is an integer from 0 to 100, the letter b is an integer from 1 to 10, the letter c is an integer from 1 to 10, the letter d is an integer from 1 to 10, the letter e is an integer from 0 to 1,000, the letter f is an integer from 0 to 1,000, the letter g is an integer from 0 to 1,000, the letter h is an integer from 1 to 1,000, the letter i is an integer from 0 to 100, and the sum e+f+g+h is an integer from 10 to 4,000.

Illustrative examples of R⁶ and R⁷ include a hydrogen atom, methyl, ethyl, n-butyl, 2-ethylhexyl, and 2-hydroxyethyl. Preferred ranges for the letters a to i are as follows. That is, it is preferable for the letter a to be an integer from 1 to 50, for the letter b to be an integer from 1 to 5, for the letter c to be an integer from 1 to 5, for the letter d to be an integer from 1 to 5, for the letter e to be an integer from 0 to 10, for the letter f to be an integer from 50 to 200, for the letter g to be an integer from 0 to 10, for the letter h to be an integer from 1 to 100, for the letter I to be an integer from 3 to 20, and for the sum e+f+g+h to be an integer from 50 to 500.

The amount of component F included is typically from 0.1 to 100 parts by weight, and preferably from 1 to 50 parts by weight, per 100 parts by weight of component A.

The solvent serving as component G may be a solvent that is commonly used for industrial purposes. However, taking into consideration the printability onto the surfaces of molded silicone rubber materials or the like, it is preferable to use a nonpolar solvent which does not readily give rise to undesirable effects such as beading. For instance, a saturated hydrocarbon compound or a low-molecular-weight organosiloxane is suitable. Examples include hexane, heptane, mineral spirits, industrial gasoline, and non-functional straight-chain polyorganosiloxanes and cyclic polyorganosiloxanes which do not take part in the hydrosilylation addition reaction between components A and B. Hexane, heptane, straight-chain dimethylpolysiloxanes and cyclic dimethylpolysiloxanes are especially preferred. Because it is necessary to allow the solvent to evaporate after printing, the above-mentioned non-functional straight-chained or cyclic organopolysiloxane preferably has a low boiling point (high volatility). Low-molecular-weight organosiloxanes which have the best wettability (leveling characteristics) on silicone rubber surfaces and the like, and which have a boiling point at a pressure of 666 Pa (about 5 torr) of not above 100° C. (e.g., in which the number of silicon atoms on the molecule, or the degree of polymerization, is about 3 to about 20, and especially about 3 to about 10) are most preferred.

Component G is included in an amount of typically from 10 to 10,000 parts by weight, preferably from 50 to 2,000 parts by weight, and more preferably from 100 to 1,000 parts by weight, per 100 parts by weight of component A.

The silicone ink composition of the invention may be used in known inkjet printers. Examples of such inkjet printers include piezoelectric drop-on-demand systems, valve jet drop-on-demand systems, thermal systems and charge-controlled continuous systems.

After inkjet printing, the printed and image-formed ink composition may be heat set. The heat setting conditions are selected as appropriate, although heat setting can generally be carried out at from 80 to 200° C., and especially from 100 to 150° C.

The recording medium on which the ink composition of the invention is inkjet printed is not subject to any particular limitation. Illustrative examples include paper, films made of a resin such as polyethylene terephthalate or polyvinyl chloride, molded materials made of a resin such as polycarbonate or polyamide, molded materials made of a metal such as iron or aluminum, and millable or liquid silicone rubber moldings. The use of a molded silicone rubber material is especially effective.

No particular limitations are imposed on the type of silicone rubber composition that may serve as the base material in a molded silicone rubber material on the surface of which the inventive silicone ink composition is to be printed and heat set, or on the method of vulcanization or the molding method. The inventive silicone ink composition may be employed on any type of molded silicone rubber material, such as one made of a so-called millable silicone rubber composition or a liquid silicone rubber composition and produced by, for example, organic peroxide vulcanization, hydrosilylation crosslinking, silanol condensation crosslinking, compression molding, transfer molding or injection molding.

The molded silicone rubber material on the surface of which the inventive silicone ink composition has been printed and heat set can be used in the keys of rubber switches having characters and patterns printed thereon, such as keypads in cellular phones and in remote controls for TVs, video equipment, air conditioners and the like, and switches for on-board components in vehicles. Compared with the image quality of prior-art screen-printing, molded silicone rubber materials having a printed surface of excellent image quality can be obtained through the use of inkjet printing.

### EXAMPLES

Examples of the invention and the Comparative Examples are provided below by way of illustration, and not by way of limitation.

### Examples 1 to 7, Comparative Examples 1 to 3

The silicone ink compositions in Examples 1 to 7 and Comparative Examples 1 to 3 were prepared by formulating the respective ingredients shown in Table 1 in the indicated amounts. The ingredients used in preparing the above silicone ink compositions of the invention are specified below.
A-1: Formula (2) type; n=approx. 200
A-2: Formula (3) type; n=approx. 200, m1=approx. 3
B-1: Formula (7) type; p=0, q1=approx. 40
B-2: Formula (8) type; p=approx. 20, q2=approx. 20
C: Hexachloroplatinic acid/n-butanol solution (platinum conc.=2 wt %)
D: Ethynyl cyclohexanol
E-1: Copper phthalocyanine pigment (blue)
E-2: Quinacridone pigment (red)
E-3: Nitrophenylazo-amide pigment (yellow)
E-4: Titanium dioxide (white pigment)
E-5: Carbon (black pigment)
F-1: Formula (15) type
F-2: Formula (13) type
F-3: Formula (12) type
G-1: Cyclic dimethylpolysiloxane (degree of polymerization=5)
G-2: Acyclic dimethylpolysiloxane (degree of polymerization=5)
G-3: n-Heptane

Preparation of the silicone ink composition in the respective examples was carried out by the following method.

First, each of the ingredients other than the platinum catalyst (C) and the reaction regulator (D) were measured out and added to a reactor in the amounts indicated in Table 1, then mixed together to form a premix. The premix was then continuously circulated through a bead mill (Dyno-Mill, manufactured by Willy A Bachofen AG) packed (85%) with 0.3 mm zirconia beads, and dispersed (circumferential velocity=10 m/s, 240 minutes) so as to give an ink base.

Next, the platinum catalyst (C) and the reactor regulator (D) were added in the amounts indicated in Table 1 to the respective ink bases thus obtained, then filtered with a Profile Star filter (Pall Corporation) having a filtration accuracy of 5 μm, yielding a thermosetting silicone ink composition for inkjet printing. Because the composition prepared in Comparative Example 1 causing filter clogging, filtration in this example was carried out at a filtration accuracy of 20 μm.

### [Method of Evaluation]

The pigment dispersibility for each of the silicone ink compositions obtained as described above was evaluated by centrifugal separation and average particle size measurement.

### Centrifugal Separation

The respective silicone ink compositions were placed in test tubes and centrifugally separated in a centrifuge at 4,500 rpm for 5 minutes. Settling of the pigment was rated according to the following criteria. The results are shown in Table 2.
−: A clear layer did not form at the top of the liquid phase, and settling of the pigment did not occur.
+: The pigment settled, and a clear layer formed at the top of the liquid phase.

### Average Particle Size Measurement

The volume base cumulative mean diameter of dispersed pigment was measured with a Microtrack MT3000 (Nikkiso Co., Ltd.) through which the solvent (G) of the respective silicone ink compositions was circulated. The results are shown in Table 2.

Next, to evaluate the inkjet printing properties of each of the silicone ink compositions, the ink was filled into an inkjet printer (PC Corder JET-HQ500, manufactured by Kishugiken Kogyo KK), a pattern was printed onto the surface of a 2 mm thick cured sheet of millable silicone rubber (KE-951-U, manufactured by Shin-Etsu Chemical Co., Ltd.), and both the printer head and printed state were examined.

### Printer Head

The printhead on the inkjet printer was examined for clogging of the nozzles and rated according to the following criteria. The results are shown in Table 2.
−: Nozzle clogging did not occur, enabling the complete pattern to be printed.
+: Nozzle clogging occurred, as a result of which some or all of the marks to be printed were missing.

### Printed State

The printed state after the ink droplets landed on the silicone rubber sheet was examined and rated according to the following criteria. The results are shown in Table 2.
−: Due to proper leveling, there was no beading or bleeding.
+: Beading and bleeding arose.

In addition, the printed patterns on silicone rubber sheets obtained as described above were air-dried at room temperature for 30 minutes to allow the solvent to evaporate, after which they were placed in a 150° C. oven for 10 minutes to cure the silicone ink composition. The print characteristics were then evaluated based on the curability and adherence of the silicone ink composition. The results are shown in Table 2.

### Curability

The printed pattern was touched with a finger, following which the surface state was examined and rated according to the following criteria. The results are shown in Table 2.

Good: Cured without surface tack.

Fair: Cured, but surface tack remained (undercured).

NG: Did not cure.

### Adherence

A fingernail was scraped across the printed pattern, following which the surface state was examined and rated according to the following criteria. The results are shown in Table 2.

Good: Did not peel from the silicone rubber surface.

NG: Readily peeled from the silicone rubber surface.

--: Did not cure.

TABLE 1

| | | | | | | | | | Comparative | | |
|---|---|---|---|---|---|---|---|---|---|---|---|
| Ingredients | | Example | | | | | | | Example | | |
| (pbw) | | 1 | 2 | 3 | 4 | 5 | 6 | 7 | 1 | 2 | 3 |
| Ingredient A | A-1 | 10 | 10 | 10 | 10 | 10 | | | 10 | 10 | 10 |
| | A-2 | | | | | | 10 | 10 | | | |
| Ingredient B | B-1 | 1 | 1 | 1 | 1 | 1 | | | 1 | 1 | |
| | B-2 | | | | | | 2 | 2 | | | |
| Ingredient C | C | 0.1 | 0.1 | 0.1 | 0.1 | 0.1 | 0.1 | 0.1 | 0.1 | | 0.1 |
| Ingredient D | D | 0.05 | 0.05 | 0.05 | 0.05 | 0.05 | 0.05 | 0.05 | 0.05 | 0.05 | 0.05 |
| Ingredient E | E-1 | 3 | | | | | 3 | 3 | 3 | 3 | 3 |
| | E-2 | | 3 | | | | | | | | |
| | E-3 | | | 3 | | | | | | | |
| | E-4 | | | | 3 | | | | | | |
| | E-5 | | | | | 3 | | | | | |
| Ingredient F | F-1 | 2 | | | | 2 | 2 | 2 | | 2 | 2 |
| | F-2 | | 2 | | | | | | | | |
| | F-3 | | | 2 | 2 | | | | | | |
| Ingredient G | G-1 | 84 | 84 | 84 | 84 | 84 | | | 86 | 84 | 85 |
| | G-2 | | | | | | 83 | | | | |
| | G-3 | | | | | | | 83 | | | |

TABLE 2

| | | | | | | | | Comparative | | |
|---|---|---|---|---|---|---|---|---|---|---|
| | Example | | | | | | | Example | | |
| | 1 | 2 | 3 | 4 | 5 | 6 | 7 | 1 | 2 | 3 |
| Ink appearance | blue | red | yellow | white | black | blue | blue | blue | blue | blue |
| Pigment settled | − | − | − | − | − | − | − | + | − | − |
| during centrifugal | | | | | | | | | | |
| separation | | | | | | | | | | |
| Average particle | 0.5 | 1.0 | 1.5 | 0.5 | 0.5 | 1.0 | 1.5 | 5.0 | 0.5 | 0.5 |
| size (μm) | | | | | | | | | | |
| Nozzle clogging | − | − | − | − | − | − | − | + | − | − |
| Beading, bleeding | − | − | − | − | − | − | − | − | − | − |
| of printed marks | | | | | | | | | | |
| Curability | good | good | good | good | good | good | good | good | NG | NG |
| Adherence | good | good | good | good | good | good | good | good | — | — |

Japanese Patent Application No. 2006-160791 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A silicone ink composition for inkjet printing, comprising:
(A) an organopolysiloxane having two or more alkenyl groups on the molecule,
(B) an organohydrogenpolysiloxane having two or more hydrosilyl groups on the molecule,
(C) a platinum catalyst,
(D) a reaction regulator,
(E) a pigment,
(F) a dispersant, and
(G) a solvent.

2. The composition of claim 1, wherein the pigment is of at least one type selected from the group consisting of inorganic pigments and organic pigments.

3. The composition of claim 1, wherein the dispersant is a silicone-modified resin.

4. The composition of claim 3, wherein the silicone-modified resin is of at least one type selected from the group consisting of amino group-containing silicone oils, carboxyl group-containing silicone oils, carbinol group-containing silicone oils, alkyl group-containing silicone oils and copolymers of a radical polymerizable monomer and a silicone oil in which one end of the molecular chain is terminated with (meth)acrylate group.

5. The composition of claim 1, wherein the solvent is a low-molecular-weight organosiloxane having a boiling point at a pressure of 666 Pa of not above 100° C.

6. The composition of claim 1 which is adapted for printing onto a surface of a cured silicone rubber material.

7. An image-forming method comprising the steps of:
forming an image on a recording medium by inkjet printing using the silicone ink composition of claim 1, then
crosslinking the image formed by the silicone ink composition.

8. The method of claim 7, wherein the recording medium is a cured silicone rubber material.
